(19) United States
(12) Patent Application Publication
(10) Pub. No.: US 2008/0069549 A1
(43) Pub. Date: Mar. 20, 2008

(54) Radiant heater warmer

(75) Inventors: Vincent P. Tippmann JR., Ft. Wayne, IN (US); Joseph R. Tippmann, Ft. Wayne, IN (US)

Correspondence Address: BIRCH STEWART KOLASCH & BIRCH, PO BOX 747, FALLS CHURCH, VA, 22040-0747, US

(73) Assignee: THERMODYNE FOODSERVICE PRODUCTS, INC., Fort Wayne, IN (US)

(21) Appl. No.: 11/902,191

(22) Filed: Sep. 19, 2007

Related U.S. Application Data
(60) Provisional application No. 60/845,530, filed on Sep. 19, 2006.

(51) Int. Cl. F26B 3/30

(52) U.S. Cl. 392/411

(57) ABSTRACT

A radiant heater warmer apparatus for maintaining a liquid product in a heated condition includes a base for supporting a container. A heat source or a light source is operatively mounted within the base for providing radiant heat to the container or for shining a beam of light into a clear container for heating a liquid product disposed therein. By providing radiant heat or by illuminating the clear container with the beam of light the liquid product disposed within the container or the clear container is maintained at a predetermined temperature.

### BACKGROUND OF THE INVENTION

1. Field of the Invention

The present invention is directed to a radiant heater warmer apparatus for maintaining a liquid product at a predetermined temperature by using radiant heat or by shining a beam of light into the container for heating the liquid product disposed therein.

2. Description of Background Art

Heretofore, a liquid product, such as coffee, is maintained in a heated condition by placing the container holding the liquid directly on a heat source, such as a burner. Normally, three points of contact are made between the container and the burner for conducting the heat of the burner to the container. At the points of contact with the burner, the container is heated to a very high temperature that results in a burning of the liquid within the container. If coffee is disposed in the container, over a predetermined period of time the coffee is burned and the liquid within the container is boiled off to produce a coffee product that is not fit for consumption.

In addition, a thermos may be used for storing a heated liquid. However, with time the liquid within the thermos will cool and thus become unsuitable for consumption.

### SUMMARY AND OBJECTS OF THE INVENTION

It is an object of an embodiment of the present invention to provide a radiant heater for maintaining a liquid within a clear container at a predetermined temperature without adversely affecting the taste of the liquid.

Another object of an embodiment of the present invention is to provide a radiant heater that may be adjusted in intensity for varying the intensity of light that may be transmitted through a clear container for maintaining the liquid at a predetermined temperature without adversely affecting the taste of the liquid.

It is a further object of an embodiment of the present invention to provide a radiant heater for maintaining a liquid within a container at a predetermined temperature by displacing the container to be at a slight elevation relative to a burner for heating the container by use of radiant heat while eliminating the point contact between the container and the burner.

These and other objects of an embodiment of the invention are achieved by providing a radiant heater warmer apparatus for maintaining a liquid product at a predetermined temperature. A base is provided for supporting a container. A light source or a burner is operatively mounted within the base for providing heat for heating a liquid product disposed within the container. By heating the container with radiant heat from the burner or illuminating the clear container with a beam of light the liquid product disposed within the container is maintained at a predetermined temperature without adversely affecting the taste of the liquid.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a view illustrating a radiant heater warmer with a light disposed in a base for maintaining a liquid in a container at a predetermined temperature;

FIG. 2 is a view illustrating a radiant heater warmer with a halogen light disposed in a base for maintaining a liquid in a container at a predetermined temperature;

FIG. 3 is a view illustrating a radiant heater warmer with a plurality of halogen lights disposed in a base for maintaining a liquid in a container at a predetermined temperature; and

FIG. 4 is a view illustrating a radiant heater warmer with a burner disposed in a base for maintaining a liquid in a container at a predetermined temperature.

### DETAILED DESCRIPTION OF THE PREFERRED EMBODIMENTS

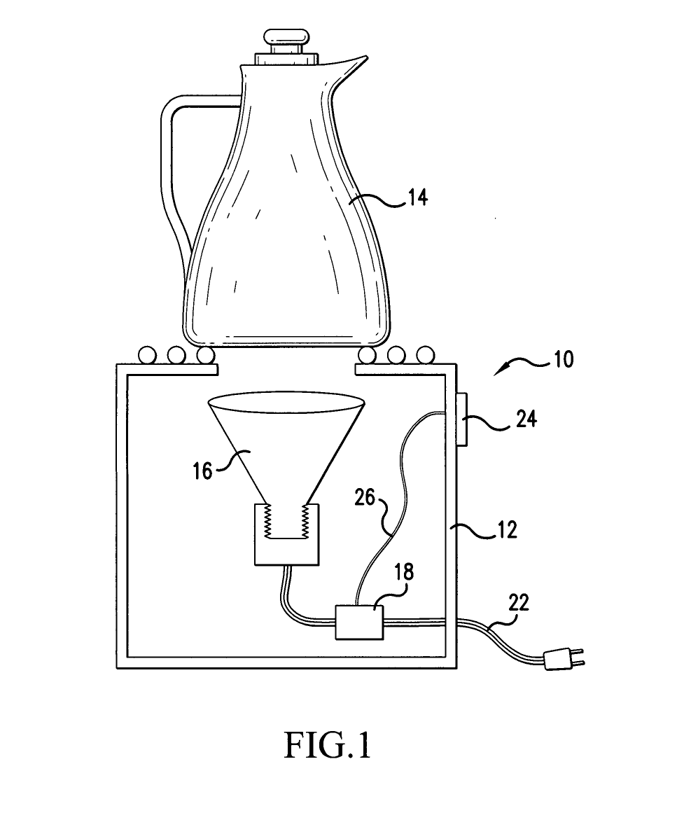

As illustrated in FIG. 1, a radiant heater warmer apparatus 10 is provided for maintaining a liquid product in a heated condition. The radiant heater warmer apparatus 10 includes a base 12 adapted to support a clear container 14. A light source 16 is operatively mounted within the base 12 for shining a beam of light into the clear container 14 for heating a liquid product disposed therein. By illuminating the clear container 14 with the beam of light, the liquid is maintained at a predetermined temperature.

As illustrated in FIG. 1, the radiant heating apparatus 10 may include a rheostat 18 that is operatively connected to a source of electrical power supplied through the cord 22. A control knob 24 may be provided for manually adjusting the voltage applied to the light source 16 for varying the intensity of the beam of light that is illuminated onto the clear container 14. The control knob 24 is operatively connected to the rheostat 18 by an electrical connection 26.

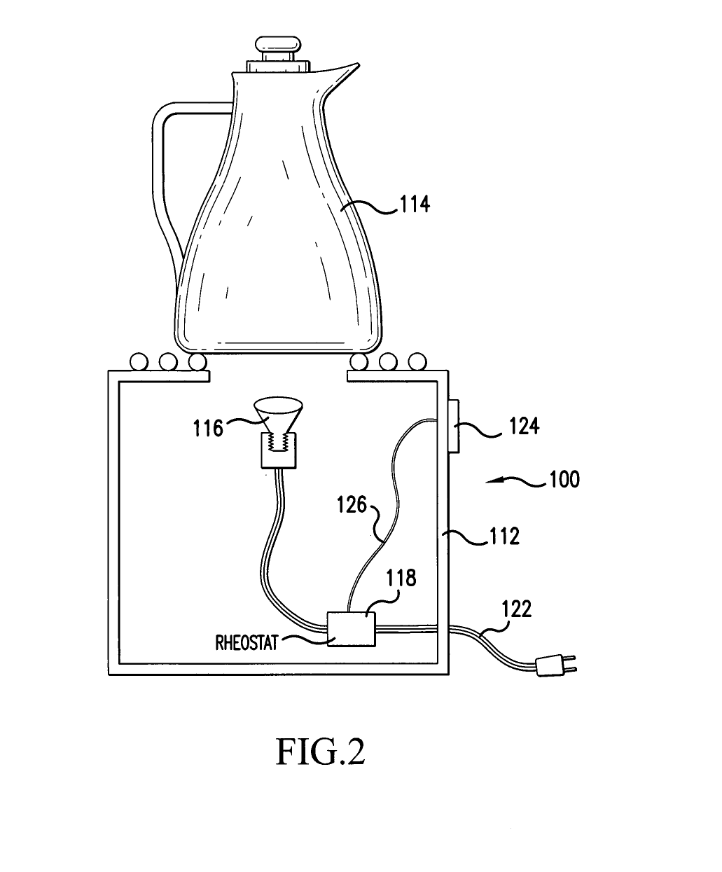

As illustrated in FIG. 2, the radiant heating apparatus 100 includes a base 112 that may include a light source consisting of at least one halogen light 116 wherein the beam of light from the halogen light 116 illuminates a bottom portion of the clear container 114. As illustrated in FIG. 2, the radiant heating apparatus 100 may include a rheostat 118 that is operatively connected to a source of electrical power supplied through the cord 122. A control knob 124 may be provided for manually adjusting the voltage applied to the halogen light 116 for varying the intensity of the beam of light that is illuminated onto the clear container 114. The control knob 124 is operatively connected to the rheostat 118 by an electrical connection 126.

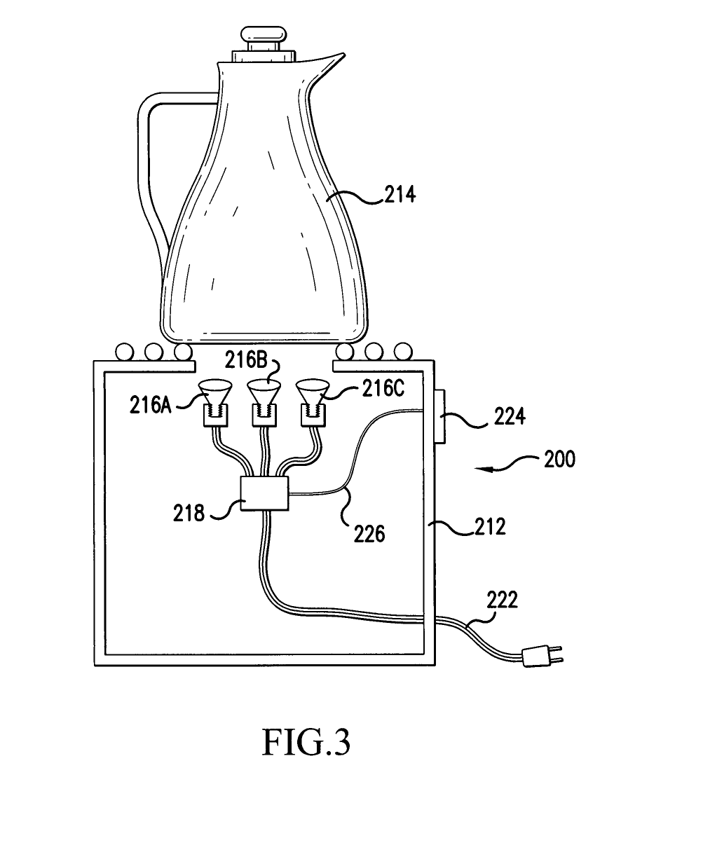

As illustrated in FIG. 3, the radiant heating apparatus 200 includes a base 212 that may include a light source consisting of a plurality of halogen lights 216A, 216B and 216C wherein a plurality of beams of light from the halogen lights 216A, 216B and 216C illuminate a bottom portion of the clear container 214. As illustrated in FIG. 3, the radiant heating apparatus 200 may include a rheostat 218 that is operatively connected to a source of electrical power supplied through the cord 222. A control knob 224 may be provided for manually adjusting the voltage applied to the halogen light 216 for varying the intensity of the beam of light that is illuminated onto the clear container 214. The control knob 224 is operatively connected to the rheostat 218 by an electrical connection 226. The plurality of halogen lights 216A, 216B and 216C may be arranged in series with 50 to 90 watt bulbs being utilized for illuminating the bottom of the container 214.

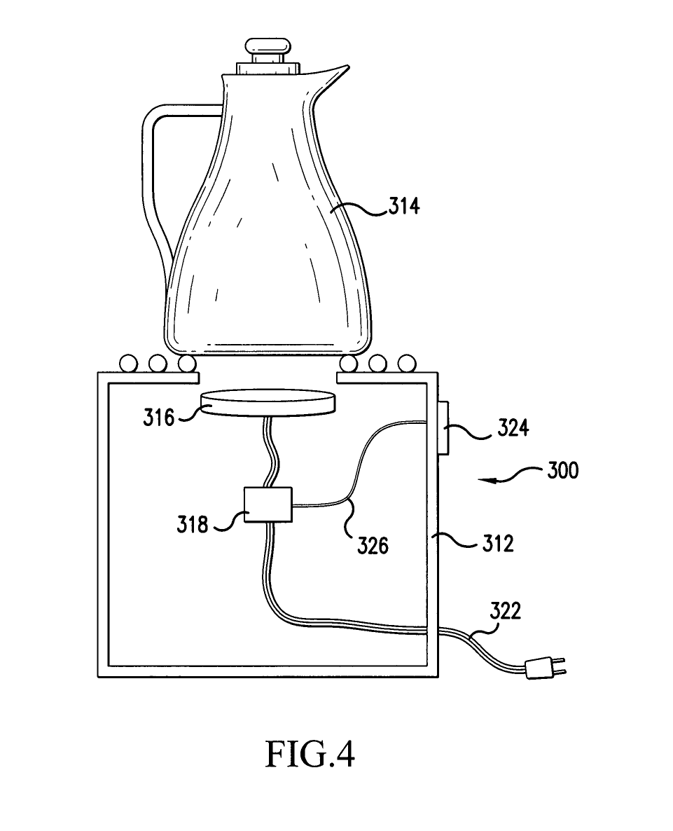

As illustrated in FIG. 4, a radiant heating apparatus 300 includes a base 312 that is adapted to support a container 314. A source of heat 316 is operatively mounted within the base 312 for providing radiant heat for heating a liquid product disposed in the container 314. By supplying radiant heat to the container 314 a liquid product disposed within the container 314 is maintained at a predetermined temperature.

According to the embodiment illustrated in FIG. 4, the radiant heating apparatus 300 may include a heat source 316 that is a burner that is displaced a predetermined distance relative to a bottom portion of said container. In this way, the bottom of the container does not contact the burner. Thus, radiant heat and not conducting heat is utilized for maintaining the temperature of the liquid product disposed with the container 314.

As illustrated in FIG. 4, the radiant heating apparatus 300 may include a rheostat 318 that is operatively connected to a source of electrical power supplied through the cord 322. A control knob 324 may be provided for manually adjusting the voltage applied to the source of heat 316 for varying the intensity of the heat that is radiated onto the bottom of the container 314. The control knob 324 is operatively connected to the rheostat 318 by an electrical connection 326. According to the embodiment illustrated in FIG. 4, the source of heat 316 may be an electrical heater.

In an embodiment of the present invention, the liquid in the containers 14, 114, 214 or 314 may be coffee. By using radiant heat to maintain the coffee at a predetermined temperature the present invention avoids problems in the prior art wherein the coffee is burned by using conduction to heat at least three points on the bottom of the container. Normally, if conduction heat is used, the coffee would be heated to 300 to 500 degrees Fahrenheit at the three points of contact with the container which will result in a burning of the coffee located in the particular areas in the container adjacent to the three points of contact. In addition, the conduction heat applied to the container will result in a boiling off of the water in the coffee which will render the coffee unfit for consumption. The present invention avoids the problems of the prior art to provide coffee or soup that is maintained at a predetermined temperature without burning or boiling off the product to make it unacceptable for consumption.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A radiant heater warmer apparatus for maintaining a liquid product in a heated condition comprising:
a base adapted to support a container; and
a source of heat operatively mounted within said base for providing radiant heat for heating a liquid product disposed therein;
wherein supplying radiant heat to said container a liquid product disposed within said container is maintained at a predetermined temperature.

2. The radiant heating apparatus according to claim 1, wherein said heat source is a burner that is displaced a predetermined distance relative to a bottom portion of said container.

3. The radiant heating apparatus according to claim 1, and further including a rheostat operatively connected to a source of electrical power and said source of heater for manually adjusting the voltage applied to said source of heater for varying the intensity of the heat supplied to the container.

4. The radiant heating apparatus according to claim 1, wherein the container is a clear container.

5. The radiant heating apparatus according to claim 1, wherein the source of heat is an electrical heater for supplying radiant heat to said container.

6. A radiant heater warmer apparatus for maintaining a liquid product in a heated condition comprising:
a base adapted to support a clear container; and
a light source operatively mounted within said base for shining a beam of light into said clear container for heating a liquid product disposed therein;
wherein illuminating said clear container with said beam of light maintains a liquid product disposed within said clear container at a predetermined temperature.

7. The radiant heating apparatus according to claim 6, wherein said light source is at least one halogen light wherein the beam of light from said halogen light illuminates a bottom portion of said clear container.

8. The radiant heating apparatus according to claim 6, and further including a rheostat operatively connected to a source of electrical power and said light source for manually adjusting the voltage applied to said light source for varying the intensity of the beam.

9. The radiant heating apparatus according to claim 6, wherein said light source is a plurality of halogen lights arranged in series for shining a plurality of beams of light onto a bottom portion of said clear container.

10. The radiant heating apparatus according to claim 6, wherein the liquid to be heated is coffee.

11. The radiant heating apparatus according to claim 6, wherein the liquid to be heated is a soup.
